(19) United States
(12) Patent Application Publication
(10) Pub. No.: US 2013/0048097 A1
(43) Pub. Date: Feb. 28, 2013

(54) THERMAL PHASE SEPARATION

(71) Applicant: Gregory S. Mungas, Mojave, CA (US)

(72) Inventor: Gregory S. Mungas, Mojave, CA (US)

(73) Assignee: FIRESTAR ENGINEERING, LLC, Mojave, CA (US)

(21) Appl. No.: 13/599,756

(22) Filed: Aug. 30, 2012

Related U.S. Application Data
(60) Provisional application No. 61/529,056, filed on Aug. 30, 2011.

(51) Int. Cl. F16L 53/00

(52) U.S. Cl. 137/13; 137/334

(57) ABSTRACT

A thermal variation source (e.g., a heater or a heat sink) is used to induce a temperature gradient across an interior surface of a storage tank. The storage tank stores a working fluid (e.g., a fuel, and oxidizer, or a monopropellant) that may have pockets of gaseous-phase working fluid interspersed within liquid-phase working fluid, or vice versa. In the absence of gravity or other significant forces on the working fluid, the temperature gradient is sufficient to cause phase-separation of the working fluid and allow either the liquid-phase or the gaseous-phase working fluid to be withdrawn from the storage tank, as desired.

### CROSS-REFERENCE TO RELATED APPLICATIONS

The present application claims benefit of priority to U.S. Provisional Patent Application No. 61/529,056, entitled “Thermal Phase Separation,” and filed on Aug. 30, 2011, which is specifically incorporated by reference herein for all that it discloses or teaches. The present application is further related to International Application No. PCT/2012/______, entitled “Thermal Phase Separation,” and filed on Aug. 30, 2012, which is also specifically incorporated by reference herein for all that it discloses or teaches.

### BACKGROUND

Thruster or rocket engines intended to be used in vacuum or near vacuum environments (e.g., the Earth's upper atmosphere and space) utilize combustion of stored fuel and oxidizer to produce thrust. The fuel and oxidizer may be stored separately and combined prior to combustion (i.e., a bipropellant) or premixed and stored prior to combustion (i.e., a monopropellant.

Many fuels, oxidizers, and monopropellants (hereinafter working fluids) are stored at a pressure and temperature that allows the working fluids to exist in both liquid and gaseous phases within a storage tank. While both liquid and gaseous phases of a working fluid may be combusted to produce thrust, it is often desirable to draw a single phase fluid out of the storage tank. For example, the liquid-phase contains more available energy per unit volume than the gaseous-phase. Further, pressure drop through the feed system is typically greater for lower density gases compared to liquids. Variation in withdrawal of liquids and gases from the storage tank may cause variations in downstream pressure that are difficult to regulate. In some circumstances, when the working fluid undergoes combustion downstream, feed system pressure oscillations can produce combustion instabilities that can cause an engine or other combustion system to catastrophically fail. Regulation of two-phase fluids utilizing conventional pressure regulation techniques can be challenging. In some cases, regeneratively-cooled engines or combustion systems may not be capable of burning gaseous-phase working fluids without inducing a thermal failure mode in the engine. Therefore, combusting the liquid-phase working fluid may be advantageous compared to combusting the gaseous-phase working fluid. Further, combustion of part liquid-phase and part gaseous-phase working fluid can produce a varying output that may be undesirable in implementations where output magnitude is carefully controlled (e.g., thrust applications). As a result, it is often desired to consistently draw either liquid-phase or gaseous-phase working fluid from a tank storing the working fluid in both phases.

### SUMMARY

Implementations described and claimed herein address the foregoing problems by providing a method comprising inducing phase-separation of a working fluid contained within a storage tank responsive to a temperature gradient applied across an interior surface of the storage tank.

Implementations described and claimed herein address the foregoing problems by further providing a thermal phase-separation storage tank comprising a thermal variation source that applies a temperature gradient across an interior surface of the storage tank and induces phase-separation of a working fluid contained within the storage tank.

Other implementations are also described and recited herein.

### BRIEF DESCRIPTIONS OF THE DRAWINGS

FIG. 1 is a cross-sectional perspective view of an example vessel utilizing a thermal phase-separation storage tank.

FIG. 2 is a cross-sectional perspective view of an example vessel utilizing two thermal phase-separation storage tanks

FIG. 3 is a cross-sectional elevation view of an example thermal phase-separation storage tank storing intermixed liquid-phase and gaseous-phase working fluid.

FIG. 4 is a first example pressure-temperature phase diagram illustrating liquid and gaseous phases of a working fluid in an example thermal phase-separation storage tank.

FIG. 5 is a second example pressure-temperature phase diagram illustrating liquid and gaseous phases of a working fluid in an example thermal phase-separation storage tank.

FIG. 6 is a cross-sectional elevation view of an example heated thermal phase-separation storage tank storing a separated liquid-phase and gaseous-phase working fluid.

FIG. 7 is a cross-sectional elevation view of an example cooled thermal phase-separation storage tank storing a separated liquid-phase and gaseous-phase working fluid.

FIG. 8 illustrates a vapor pressure and density distribution of an example monopropellant.

FIG. 9 illustrates a diagram of example monopropellant phase changes within a thermal phase separation storage tank as a function of bulk density and temperature.

FIG. 10 illustrates a graph of pressure vs. temperature curves for each of a series of example monopropellants with varying bulk densities stored within a thermal phase separation storage tank.

FIG. 11 illustrates a graph of enthalpy of nitrous oxide and two example monopropellants as a function of temperature.

FIG. 12 illustrates a graph of a derivative of an example monopropellant vapor pressure curve as a function of temperature.

FIG. 13 illustrates example operations for thermally separating liquid-phase working fluid from gaseous-phase working fluid within a thermal phase-separation storage tank.

### DETAILED DESCRIPTIONS

In terrestrial applications, a difference in specific gravity of a liquid-phase working fluid as compared to the specific gravity of a gaseous-phase working fluid causes the phases to separate within a tank due to the force of gravity. More specifically, the higher density liquid-phase working fluid is forced to the bottom of the tank and the lower density gaseous-phase working fluid is forced to the top of the tank. Further, if a vessel is significantly accelerated by thrust caused by the combustion of the working fluid (or by another source of acceleration of the vessel), the liquid and gaseous phases of the working fluid separate within the tank due to inertial forces on the working fluid. More specifically, the higher density liquid-phase of the working fluid is forced in the opposite direction of the acceleration of the vessel. Ports in the tank may be physically located in order to preferentially draw liquid-phase or gaseous-phase working fluid from the tank based on expected separation of the phases within the tank by gravity or inertial forces.

In upper atmosphere or space applications where there is little to no gravity (e.g., microgravity environments) and in vessels that move relatively little in comparison to the force applied by combustion of the working fluid (e.g., a space station), there may be insufficient force to separate the working fluid phases within the tank. In one implementation, a helium-filled bladder may be used to apply pressure on the liquid-phase working fluid and prevent the liquid-phase working fluid from also existing in a gaseous-phase. As a result, liquid-phase working fluid may be drawn from the tank without a gravity or inertial force forcing phase separation of the working fluid. However, utilizing a helium bladder consumes space and decreases the overall working fluid capacity of the tank.

In another implementation, a sophisticated capillary device is contained within the tank and draws liquid-phase working fluid out of the tank through capillary action. However, the capillary device is complex and does not operate efficiently with working fluids with low or near-zero surface tension. Further, the function of both the helium-filled bladder and the capillary device depend on environmental conditions of the vessel. In environments not significantly affected by gravity or inertial forces, another mechanism for separating liquid and gaseous phases of a working fluid within a tank so that liquid-phase or gaseous-phase working fluid may be accessed consistently for combustion or other purposes may be useful.

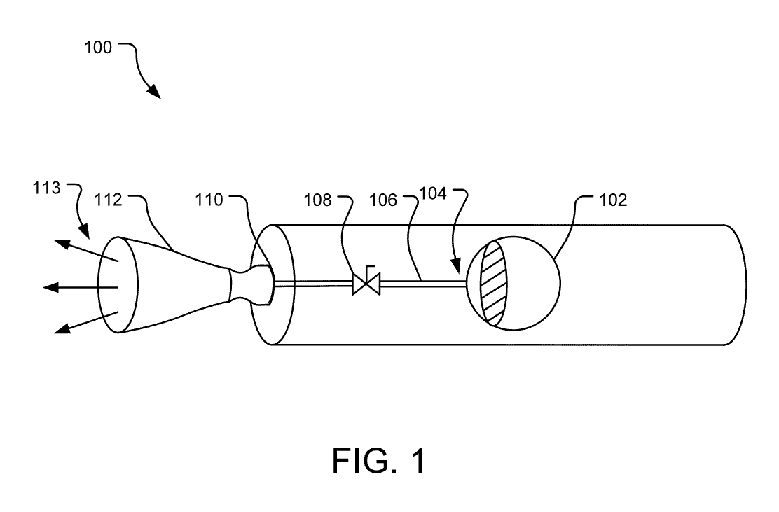

FIG. 1 is a cross-sectional perspective view of an example vessel 100 utilizing a thermal phase-separation storage tank 102. The vessel 100 could be a rocket, thruster, or other engine that converts combustion of propellant into useable energy. The storage tank 102 contains a propellant that is discharged via an outlet 104 into lines 106. One or more valves (e.g., valve 108) and/or other equipment may also be located at the discharge of the tank 102. The lines 106 lead to an ignition interface 110 where the propellant is ignited and discharges out of an expansion nozzle 112 (as illustrated by arrows 113). Due to conservation of momentum, the discharge of the combusted propellant out of the nozzle 112 generally from right to left causes the vessel 100 to be propelled from left to right in FIG. 1. In an implementation where the vessel 100 is a part of a larger vessel (e.g., vessel 100 is a thruster on a space station), the relative acceleration of the vessel 100 is insufficient to cause phase separation of the propellant within the tank 102.

The thermal phase-separation storage tank 102 includes one or both of a heater and a cooler (not shown) that creates a temperature differential on the wall of the storage tank 102. This temperature differential causes the propellant within the tank 102 to phase separate, allowing a desired single-phase of the propellant to be drawn off the tank 102 at the outlet 104. In the implementation of FIG. 1, liquid-phase propellant is drawn off the left side of the tank 102 and gaseous-phase propellant is stored at the right side of the tank 102.

The thermal phase-separation storage tank 102 includes one or both of a heater and a cooler (not shown) that creates a temperature differential on the wall of the storage tank 102. This temperature differential causes the propellant within the tank 102 to phase separate, allowing a desired single-phase of the propellant to be drawn off the tank 102 at the outlet 104. In the implementation of FIG. 1, liquid-phase propellant is drawn off the left side of the tank 102 and gaseous-phase propellant is stored at the right side of the tank 102.

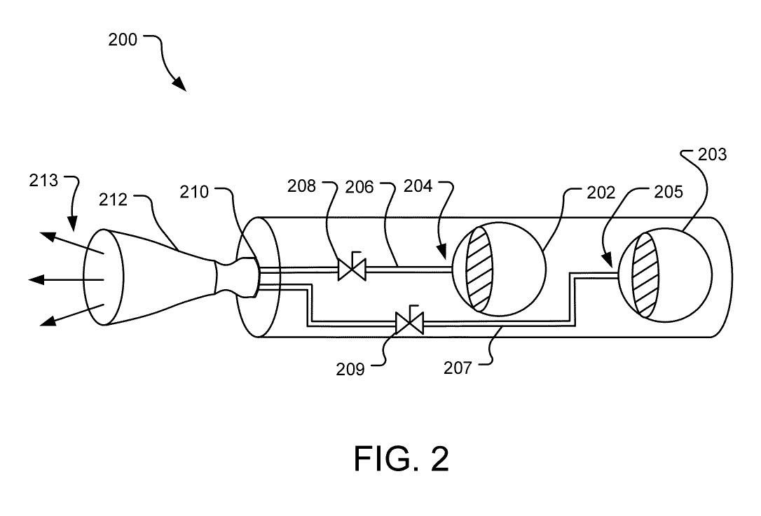

FIG. 2 is a cross-sectional perspective view of an example vessel 200 utilizing two thermal phase-separation storage tanks 202, 203. The vessel 200 could be a rocket, thruster, or other engine that converts combustion of working fluid into useable energy. The storage tanks 202, 203 each contain a working fluid that is discharged via outlets 204, 205 into lines 206, 207, respectively. The working fluid(s) may be monopropellant(s) and/or bipropellant(s). For example, in a bipropellant system, one of the tanks 202, 203 may store a fuel and the other of the tanks 202, 203 may store an oxidizer. The tanks 202, 203 are depicted as spherical but may be any volume-enclosing shape. Fuels, oxidizers, monopropellants, and bipropellants are all referred to herein as working fluids. In other implementations, additional phase-separation storage tanks may be utilized for multiple fuels, oxidizers, or both.

One or more valves (e.g., valve 208) and/or other equipment may also be located at the discharge of the tank 202. Similarly, one or more valves (e.g., valve 209) and/or other equipment may also be located at the discharge of the tank 203. The lines 206, 207 lead to the ignition interface 210 where the working fluid(s) are ignited and discharged out of an expansion nozzle 212 (as illustrated by arrows 213). In another implementation, the lines 206, 207 combine fuel discharged from one of the tanks 202, 203 and oxidizer discharged from the other of the tanks 202, 203 upstream of the ignition interface 210 so that the mixed fuel/oxidizer may be ignited at the ignition interface 210 and discharged via the nozzle 212.

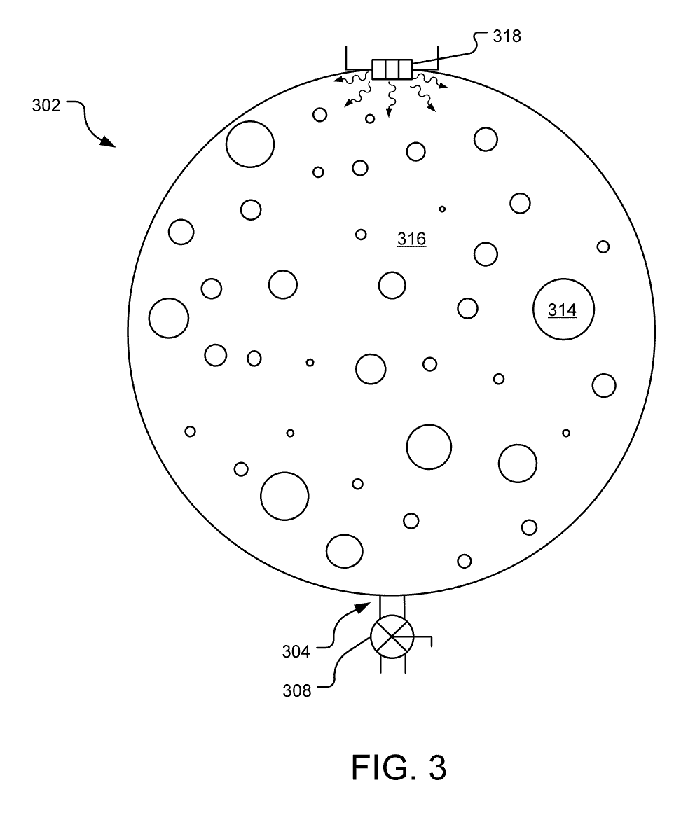

FIG. 3 is a cross-sectional elevation view of an example thermal phase-separation storage tank 302 storing intermixed liquid-phase and gaseous-phase working fluid. In an environment where gravity, inertial, or other forces are insufficient to separate liquid-phase working fluid from gaseous-phase working fluid, the phases are intermixed within the tank 302 as depicted in FIG. 3. For example, pockets of liquid-phase working fluid (e.g., pocket 314) exist within a gaseous-phase working fluid environment 316. The size and/or shape of the liquid-phase working fluid pockets may vary significantly. In other implementations, pockets of gaseous-phase working fluid instead exist within a liquid-phase portion.

The tank 302 is equipped with a heater 318 opposite an outlet 304 with a valve 308. The heater 318 emits thermal energy (depicted by wavy arrows) and causes a temperature differential from a top of the tank 302 opposite the outlet 304 to a bottom of the tank 302 at the outlet 304. Increased relative temperature of the top of the tank 302 causes liquid-phase portions of the working fluid to evaporate into a gaseous-phase. The evaporation of the liquid-phase working fluid causes gaseous-phase working fluid at the cooler bottom of the tank 302 to condense into a liquid-phase to maintain an equilibrium pressure and temperature within the tank 302. The net result is gaseous-phase working fluid collects at the top of the tank 302 and liquid-phase working fluid collects at the bottom of the tank 302.

The heater 318 may be electric or combustion driven. In another implementation, the heater 318 may merely be a conduit that channels heat generated from a separate process to the top of the tank 302 (e.g., via conduction, convection, and/or radiation). In yet another implementation, the top of the tank 302 may be placed directly adjacent heat-generating equipment.

In still another implementation, heat may be derived from combusted or decomposed propellant from the tank 302 by liberating heat from the propellant via a dedicated combustion heater, a rocket engine, or a thruster. Further, the propellant may be combusted and/or decomposed utilizing a thermodynamic cycle (e.g., a Brayton cycle, an Otto cycle, etc.) that converts the liberated thermal energy into mechanical energy. The mechanical energy can be converted into electric energy via a generator or an alternator, which in turn can be utilized to operate an electric heater. In another implementation, the propellant may be decomposed/combusted to produce heat to power a direct thermoelectric process that converts heat directly into electricity for powering an electric heater. Other implementations of the heater 318 are contemplated herein.

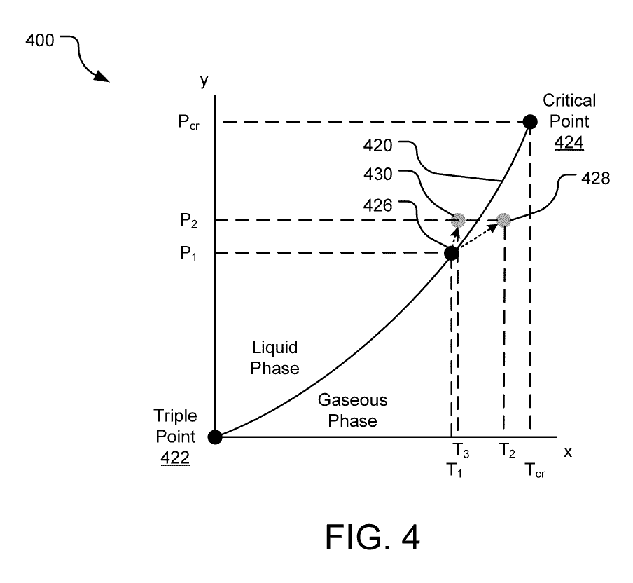

FIG. 4 is a first example pressure-temperature phase diagram 400 illustrating liquid and gaseous phases of a working fluid in an example thermal phase-separation storage tank. The phase diagram 400 illustrates temperature within the storage tank on an x-axis and pressure within the storage tank on a y-axis. Coexistence curve 420 separates the liquid-phase from the gaseous-phase of the working fluid. When the pressure and temperature of the working fluid lies on the coexistence curve, both liquid-phase and gaseous-phase working fluid may be present within the storage tank. Further, the coexistence curve 420 is illustrated between a triple point 422 and a critical point 424. The triple point 422 is the temperature and pressure at which three phases (e.g., gas, liquid, and solid) of the working fluid coexist in thermodynamic equilibrium. The critical point 424 specifies the conditions (e.g., temperature (T_{cr}), pressure (P_{cr}), and sometimes composition) at which a phase boundary ceases to exist. The coexistence curve 420 primarily illustrates the boundary conditions between liquid-phase and gaseous-phase working fluid.

For example, the storage tank may be at pressure P₁ and Temperature T₁ (i.e., at point 426) at equilibrium and have working fluid intermixed within the storage tank in both a liquid-phase and gaseous-phase. When a heating temperature differential is applied across the storage tank wall (e.g., via the heater 318 of FIG. 3), the local temperature of the working fluid near the heater rises to T₂. This forces the fluid near the heater below the curve 420 and into an exclusively gaseous-phase. Further, as the liquid near the heater evaporates, the pressure in the entire storage tank increases to P₂ (see e.g., point 428). This increase in storage tank pressure causes gaseous-phase working fluid away from the heater to be at a higher pressure than the coexistence curve 420 allows, and thus to condense into a liquid-phase (see e.g., point 430). This condensation of the working fluid releases a small amount of heat, which warms the fluid to an average temperature slightly higher than T₁.

Unlike a true thermodynamic equilibrium tank condition, this perturbed quasi-equilibrium condition produces a state where pressure is uniform throughout the storage tank, but temperature is not. The net effect of this quasi-equilibrium state maintained through application of heat is that liquid evaporates from warmer regions of the storage tank and collects in cooler regions of the storage tank at the cost of slow heating of the working fluid and an associated increase in storage tank pressure. A net result of applying a heating temperature differential to the storage tank is the separation of the gaseous-phase and liquid-phase of the working fluid within the storage tank based on the location of the heat source or sources.

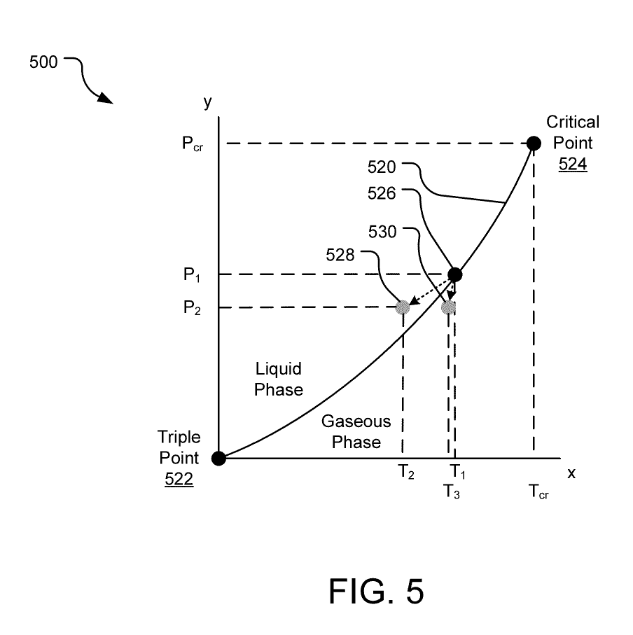

FIG. 5 is a second example pressure-temperature phase diagram 500 illustrating liquid and gaseous phases of a working fluid in an example thermal phase-separation storage tank. The phase diagram 500 illustrates temperature within the storage tank on an x-axis and pressure within the storage tank on a y-axis. Coexistence curve 520 separates the liquid-phase and gaseous-phase of the working fluid. When the pressure and temperature of the working fluid lies on the coexistence curve, both liquid-phase and gaseous-phase working fluid may be present within the storage tank. Further, the coexistence curve 520 is illustrated between a triple point 522 and a critical point 524. The triple point 522 is the temperature and pressure at which three phases (e.g., gas, liquid, and solid) of the working fluid coexist in thermodynamic equilibrium. The critical point 524 specifies the conditions (e.g., temperature (T_{cr}), pressure (P_{cr}), and sometimes composition) at which a phase boundary ceases to exist. The coexistence curve 520 primarily illustrates the boundary conditions between liquid-phase and gaseous-phase working fluid.

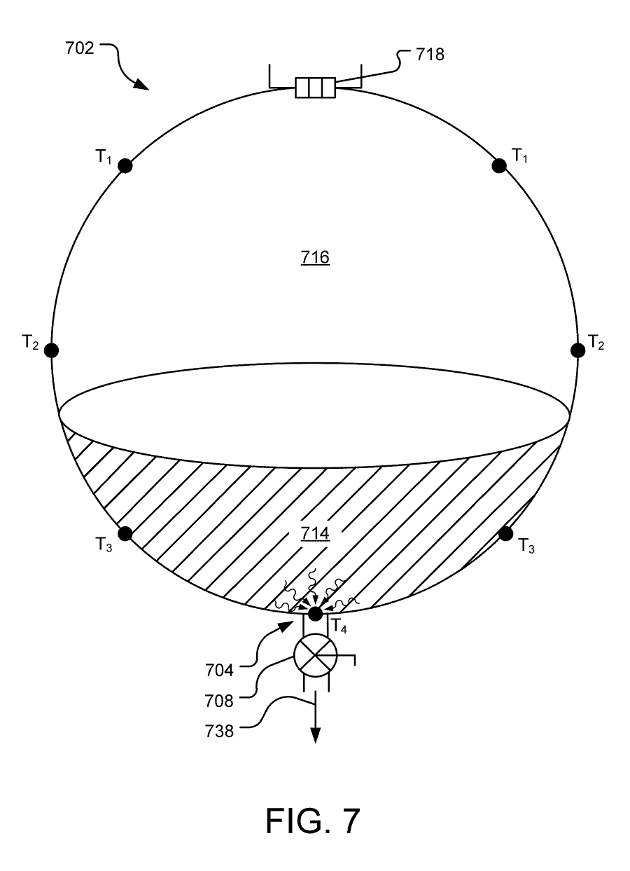

For example, the storage tank may be at pressure P₁ and Temperature T₁ (i.e., at point 526) at equilibrium and have working fluid intermixed within the storage tank in both a liquid-phase and a gaseous-phase. When a cooling temperature differential is applied across the storage tank wall (e.g., via a heat sink at outlet 704 of FIG. 7), the local temperature of the working fluid near the heat sink drops to T₂. This forces the fluid near the heat sink above the curve 520 and into an exclusively liquid-phase. Further, as the gas near the heat sink condenses, the pressure in the entire storage tank decreases to P₂ (see e.g., point 528). This decrease in storage tank pressure causes liquid-phase working fluid away from the heat sink to be at a lower pressure than the coexistence curve 520 allows, and thus to evaporate into a gaseous-phase (see e.g., point 530). This evaporation of the working fluid absorbs a small amount of heat which cools the working fluid to an average temperature slightly lower than T₁.

Unlike a true thermodynamic equilibrium tank condition, this perturbed quasi-equilibrium condition produces a state where pressure is uniform throughout the storage tank, but temperature is not. The net effect of this quasi-equilibrium state maintained through application of a heat sink is that liquid collects in cooler regions of the storage tank and evaporates from warmer regions of the storage tank at the cost of slow cooling of the working fluid and an associated decrease in storage tank pressure. A net result of applying a cooling temperature differential to the tank is the separation of the gaseous-phase and liquid-phase of the working fluid within the storage tank based on the location of the heat sink or sinks

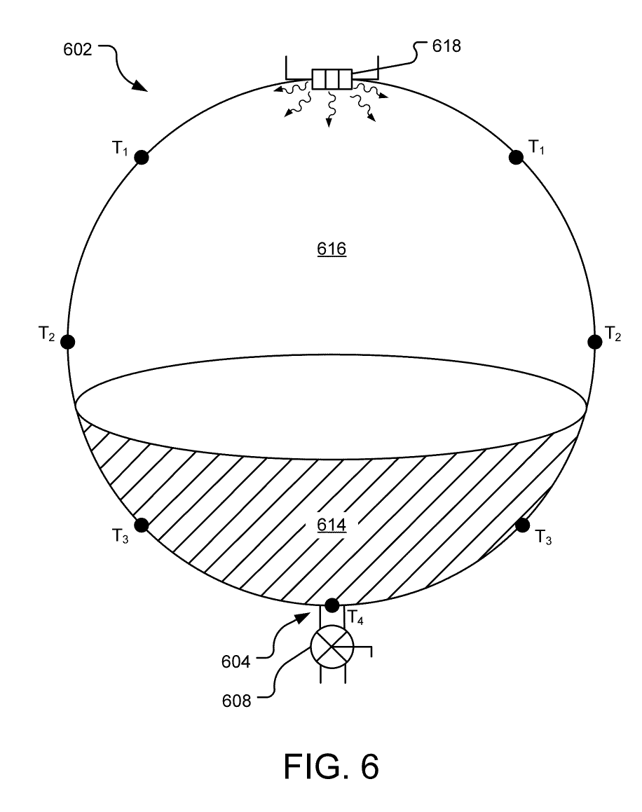

FIG. 6 is a cross-sectional elevation view of an example heated thermal phase-separation storage tank 602 storing a separated liquid-phase and gaseous-phase working fluid. The tank 602 is equipped with a heater 618 opposite an outlet 604 with a valve 608. The heater 618 emits thermal energy (depicted by wavy arrows) and causes a temperature differential from a top of the tank 602 opposite the outlet 604 to a bottom of the tank 602 at the outlet 604. Increased relative temperature of the top of the tank 602 causes liquid-phase working fluid to evaporate into a gaseous-phase. The evaporation of the liquid-phase working fluid causes gaseous-phase working fluid at the cooler bottom of the tank 602 to condense into a liquid-phase to maintain equilibrium pressure and temperature within the tank 602. The net result is the gaseous-phase working fluid 616 accumulates at the top of the tank 602 and the liquid-phase working fluid 614 accumulates at the bottom of the tank 602.

A temperature gradient sufficient to cause separation of the gaseous-phase working fluid 616 and the liquid-phase working fluid 614 within the tank 602 is a function of the vapor pressure of the working fluid and environmental disturbances that induce accelerations on the fluid elements that tend to mix the liquid-phase working fluid 614 and the gaseous-phase working fluid 616. In one example implementation utilizing a high vapor pressure nitrous oxide based propellant, the average applied temperature gradient can be as low as 1° C./m along the tank's surface in order to compensate for steady liquid accelerations in a cylinder of approximately 7 g's (i.e., approximately 70 m/s²) of acceleration. In practice, these imparted temperature induced accelerations on the liquid-phase may be reduced by complex two-phase working fluid interactions and storage tank 602 accelerations, but the trend is to illustrate the very high artificial gravities that may be realized with relatively low temperature gradients in high vapor pressure working fluids.

In one implementation, the thermal energy transmitted to the tank 602 via the heater 618 travels mostly along the outer wall of the tank 602 due to the high conductivity of the tank material (e.g., a metal alloy). As a result, the temperature differential may be measured as a function of distance from the heater 618 along the tank's internal surface. For example, the temperature of the tank 602 at T₁ is greater than the temperature at T₂. Further, the temperature of the tank 602 at T₂ is greater than the temperature at T₃. Still further, the temperature of the tank 602 at T₃ is greater than the temperature at T₄. Aggressive boiling and convective heat transport within the working fluid in the tank 602 associated with evaporation (and associated heat absorption) and condensation (and associated heat release) will tend to drive the working fluid to approach the thermal gradient along the tank wall as the working fluid segregates to achieve a quasi-equilibrium condition with separated fluid phases.

So long as a sufficient temperature differential is maintained relative to any external disturbances that impart fluids accelerations, the liquid-phase working fluid 614 and gaseous-phase working fluid 616 will remain substantially separated. Further, even if the temperature differential is not maintained, the liquid-phase portion 614 and gaseous-phase portion 616 may remain separated unless acted upon by other forces. As a result, the heater 618 may be operated periodically rather than continuously.

FIG. 7 is a cross-sectional elevation view of an example cooled thermal phase-separation storage tank 702 storing a separated liquid-phase and gaseous-phase working fluid. The tank 702 is equipped with a heater 718 opposite an outlet 704 with a valve 708. When the valve 708 is opened to a lower pressure area, the working fluid exits the tank 702 as illustrated by arrow 738 and further may enter a gaseous-phase as it exits the tank 702. The phase change from a liquid-phase to a gaseous-phase of part or all of the working fluid exiting the tank 702 at the outlet 704 induced by a pressure drop at the outlet 704 absorbs thermal energy (depicted by wavy arrows). This absorption of thermal energy creates a heat sink at the outlet 704 and causes a temperature differential from a bottom of the tank 702 at the outlet 704 to a top of the tank 702 opposite the outlet 704. Alternative cooling mechanisms in addition to the described evaporative throttling may also be applied at the outlet 704.

Decreased relative temperature of the bottom of the tank 702 causes gaseous-phase working fluid to condense into a liquid-phase. The condensation of the gaseous-phase working fluid causes liquid-phase working fluid at the warmer top of the tank 702 to evaporate into a gaseous-phase to attempt to maintain local equilibrium pressure and temperature within the tank 702. The net result is gaseous-phase working fluid 716 accumulates or remains accumulated at the top of the tank 702 and liquid-phase working fluid 714 accumulates or remains accumulated at the bottom of the tank 702.

In one implementation, the thermal energy absorbed from the tank 702 via the heat sink is sourced mostly from the outer wall of the tank 702 due to the high conductivity of the tank material (e.g., a metal alloy). As a result, the temperature differential may be measured as a function of distance from the heat sink along the interior tank wall. For example, the temperature of the tank 702 at T₄ is less than the temperature at T₃. Further, the temperature of the tank 702 at T₃ is less than the temperature at T₂. Still further, the temperature of the tank 702 at T₂ is less than the temperature at T₁.

In a further implementation, the heater 718 emits thermal energy (as depicted by wavy arrows in FIGS. 3 and 6) and supplements the temperature differential created by the heat sink at the bottom of the tank 702. Any heat source (e.g., heater 718) or heat sink may be used to induce the temperature differential discussed herein and is referred to as a temperature variation source. So long as this temperature differential is maintained, the liquid-phase working fluid 714 and the gaseous-phase working fluid 716 will remain separated. Further, even if the temperature differential is not maintained, the liquid-phase working fluid 714 and the gaseous-phase working fluid 716 will remain separated unless acted upon by other forces. As a result, the heater 718 and/or heat sink may be operated periodically rather than continuously.

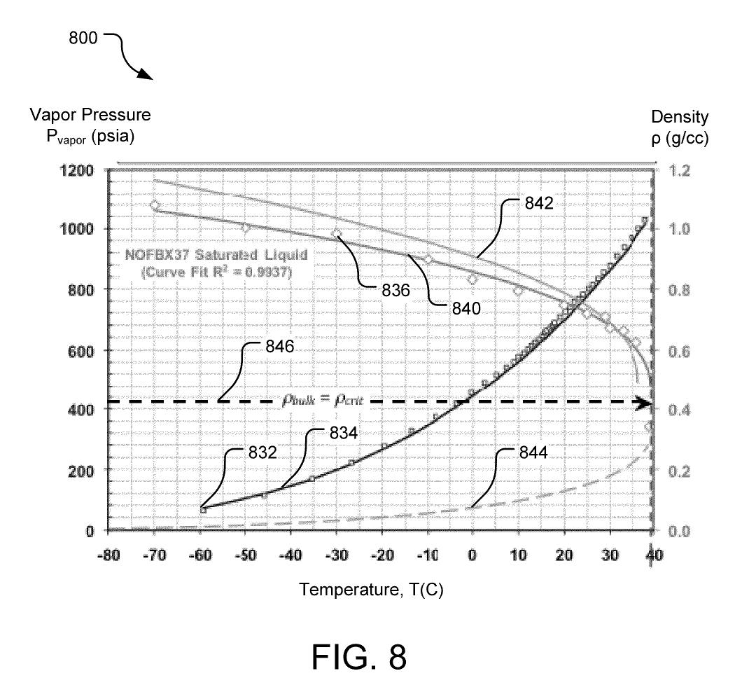

FIG. 8 illustrates a vapor pressure and density distribution 800 of an example monopropellant. The example monopropellant is a nitrous oxide—fuel blend (e.g., NOFBX™), but other monopropellant and/or bipropellant substances may field similar vapor pressure and density distributions. Square symbols (e.g., square symbol 832) illustrate experimental vapor pressure measurements of the monopropellant over a range of temperatures (i.e., about −60° C. to about 40° C.). Curve 834 is a Reidel fit to the experimental vapor pressure measurements.

The Reidel model for vapor pressure of mixtures is used to interpolate the vapor pressure curve (Pᵥₐₚ) as a function of temperature (T) for the example monopropellant based on fits to actual monopropellant experimental vapor pressure data (i.e., the square symbols) shown in FIG. 8. The Reidel model is described below:

$$ln \vert \frac{{P}_{vap}}{{P}_{c}} \vert = {P}_{r}^{( 0 )} + {ω}_{SRK} {P}_{r}^{( 1 )} \\ where \text{:} \\ {P}_{r}^{( 0 )} ≡ - 1.556640 ln {T}_{r} + 6.131436 - 6.306619 \text{/} {T}_{r} + 0.017518 {T}_{r}^{6} \\ {P}_{r}^{( 1 )} ≡ 1.265733 ln {T}_{r} + 2.99938 - 3.085075 \text{/} {T}_{r} + 0.085697 {T}_{r}^{6} \\ {T}_{r} ≡ T \text{/} {T}_{c} \\ {P}_{c} is critical pressure of the monopropellant \\ {ω}_{SRK} is an acentric factor that may be derived from curve fitting Eq . 1 to experimental data . \qquad ( 1 )$$

Diamond symbols (e.g., diamond symbol 836) illustrate experimental saturated liquid density measurements of the monopropellant over a range of temperatures (i.e., about −70° C. to about 40° C.). Curve 840 is a Spencer-Danner fit to the experimental saturated liquid density measurements.

Curve 842 illustrates saturated density changes of the nitrous oxide component of the monopropellant alone as a function of temperature. Dashed curve 844 illustrates Ullage gas density of the monopropellant as a function of temperature. Dashed line 846 illustrates where bulk density (ρ_{bulk}) of the monopropellant equals the critical density (ρ_{crit}) of the monopropellant. The distribution 800 ranges from −70° C. to about 40° C. equilibrium temperature. Above about 40° C., the monopropellant is a supercritical fluid. In one implementation, the monopropellant of FIG. 8 is stored in a thermal phase separation storage tank as discussed in detail herein.

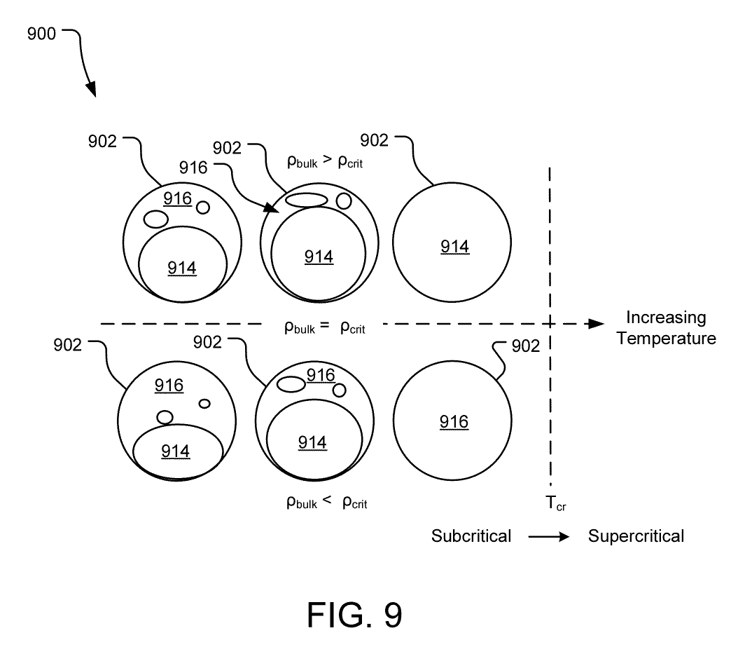

FIG. 9 illustrates a diagram 900 of example monopropellant phase changes within a thermal phase separation storage tank 902 as a function of bulk density and temperature. The storage tank 902 contains gaseous-phase monopropellant 916 and liquid-phase monopropellant (e.g., pocket 914) above and below the critical density of the monopropellant and at three distinct subcritical temperatures.

The upper-left state of storage tank 902 represents a monopropellant stored with a bulk density above its critical density. The upper left-hand state of storage tank 902 includes three discrete example pockets of liquid-phase monopropellant within the gaseous-phase monopropellant 916. In other implementations, greater or fewer pockets of liquid-phase monopropellant may exist within the storage tank 902.

The upper-center state of storage tank 902 represents the monopropellant stored at a comparatively higher temperature than that of the upper-left state of the storage tank 902, but still stored with a bulk density above its critical density. The upper-center state of storage tank 902 still includes the three discrete pockets of liquid-phase monopropellant depicted in the upper-left state, but the three pockets of liquid-phase monopropellant occupy a larger percentage of the total volume of the storage tank 902. The temperature increase of the monopropellant corresponds to an increase in pressure within the storage tank 902 as well. The pressure increase in the storage tank 902 will follow the vapor pressure curve of the liquid monopropellant and the density of the liquid-phase monopropellant will decrease as its volume expands and displaces the gaseous-phase monopropellant within the storage tank 902.

The upper-right state of storage tank 902 represents the monopropellant stored at a comparatively higher temperature than that of the upper-center state of the storage tank 902, but still stored with a bulk density above its critical density. The upper-right state of storage tank 902 no longer includes any of the gaseous-phase monopropellant 916 because the liquid-phase monopropellant has expanded to occupy the entire volume of the storage tank 902. If the temperature is increased further, the pressure in the storage tank 902 may increase rapidly due to the expansion of a nearly incompressible liquid-phase monopropellant. As the monopropellant exceeds its critical temperature (i.e., transitions from a subcritical fluid to the super critical fluid), the liquid-phase monopropellant occupying storage tank 902 becomes progressively more compressible and transitions into a gaseous-phase monopropellant (not shown) occupying the entire storage tank 902.

The lower-left state of storage tank 902 represents a monopropellant stored with a bulk density below its critical density. The lower-left state of storage tank 902 includes three discrete example pockets of liquid-phase monopropellant within the gaseous-phase monopropellant 916, which occupy less of the total volume of the storage tank 902 as compared to the upper-left state of storage tank 902 due to the comparatively lower pressure within the storage tank 902.

The lower-center state of storage tank 902 represents the monopropellant stored at a comparatively higher temperature than that of the lower-left state of the storage tank 902, but still stored with a bulk density below its critical density. The lower-center state of storage tank 902 still includes the three discrete pockets of liquid-phase monopropellant depicted in the lower-left state, but the three pockets of liquid-phase monopropellant occupy a larger percentage of the total volume of the storage tank 902.

At temperatures below the critical temperature, the monopropellant stored at a bulk loaded density less than the liquid-phase density at the associated tank temperature will be a two-phase fluid (i.e., a combination of a saturated liquid and a gas). As the monopropellant warms up, a corresponding increase in pressure will be determined by the vapor pressure of the warmest liquid-phase element in the tank. In this scenario, all of the liquid-phase monopropellant will flash into gas before the liquid-phase monopropellant can fully fill the volume of the storage tank 902 (see e.g., lower-right state of storage tank 902).

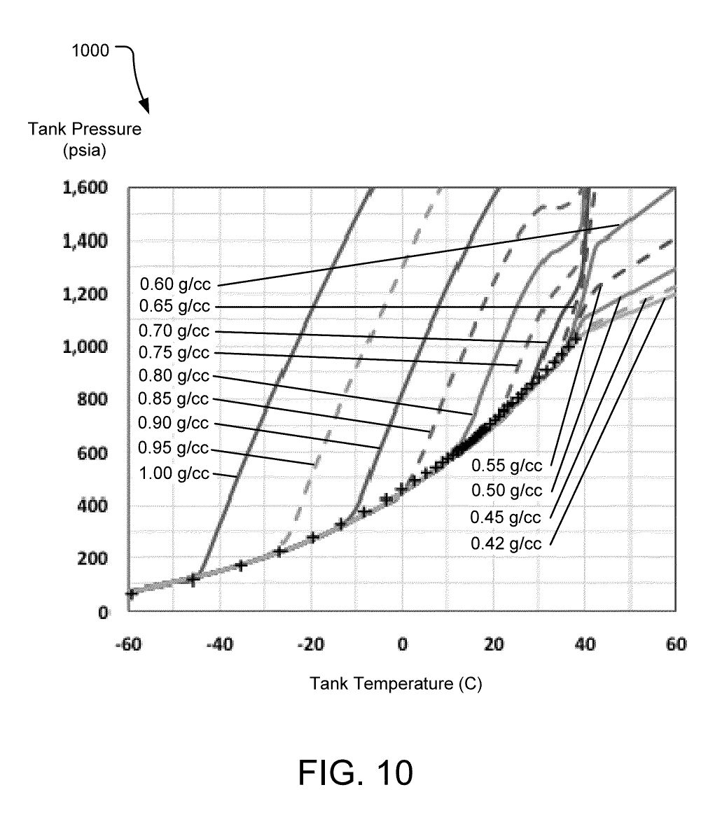

FIG. 10 illustrates a graph 1000 of pressure vs. temperature curves for each of a series of example monopropellants with varying bulk densities stored within a thermal phase separation storage tank. Graph 1000 depicts pressures ranging from about 50 psia to about 1,600 psia and temperatures ranging from about −60° C. to about 60° C. Further, the graph 1000 includes several data points (illustrated by plus signs) that were used to extrapolate the individual pressure-temperature curves for each example monopropellant bulk density. The example bulk densities range from 0.41 g/cc to 1.00 g/cc.

The curves are derived from experimental measurements of the saturated liquid line and vapor pressure measurements vs. temperature (see e.g., FIG. 8) coupled with equations of state models for incompressible fluids and supercritical fluids in close proximity to the saturated liquid line, as follows.

The Campbell-Thodos improvement to the Spencer-Danner model is used to interpolate an example nitrous oxide fuel blend monopropellant saturated liquid density curve based on fits to actual nitrous oxide fuel blend monopropellant saturated liquid density data as per the following equation.

$${ρ}_{liq , sat} ( T ) = {( \frac{{P}_{crit}}{{RT}_{crit}} ) [ α + ( 1 - T \text{/} {T}_{crit} ) β ]}^{- [ 1 + {( 1 - T \text{/} {T}_{crit} )}^{0.2857} ]} ; where \\ {ρ}_{liq , sat} is saturated liquid density of the monopropellant , \\ T is temperature of the monopropellant , \\ {P}_{crit} is the critical pressure of the monopropellant , \\ R is the ideal gas constant , \\ {T}_{crit} is the critical temperature of the monopropellant , and \\ α and β are experimental fit parameters . \qquad ( 2 )$$

For estimating the relationship between pressure, density, and temperature of subcritical fluids in the compressed liquid-phase regime, the Aalto model can be used knowing the saturated liquid density as defined in Eq. 2 above:

$$\begin{matrix}\frac{{ρ}_{liq , sat}}{{ρ}_{load}} = \frac{A ( T ) + {e}^{[ 1.0058 - T \text{/} {T}_{crit} ] B} ( {P}_{liq , comp} \text{/} {P}_{crit} - {P}_{liq , sat} \text{/} {P}_{crit} )}{A ( T ) + 2.718 ( {P}_{liq , comp} \text{/} {P}_{crit} - {P}_{liq , sat} \text{/} {P}_{crit} )} ; where & ( 3 ) \\ A ( T ) ≡ 130.010 {( \frac{T}{{T}_{crit}} )}^{- 1} - 170.335 - 28.5784 ( \frac{T}{{T}_{crit}} ) + 124.809 {( \frac{T}{{T}_{crit}} )}^{3} - 55.5393 {( \frac{T}{{T}_{crit}} )}^{6} , & ( 4 ) \\ B ( {ω}_{SRK} ) ≡ 0.164813 - 0.0914427 {ω}_{SRK} , \\ {ρ}_{load} is loaded propellant bulk density , \\ {P}_{liq , comp} is compressed liquid pressure of the monopropellant , \\ {P}_{liq , sat} is saturated liquid pressure of the monopropellant , and \\ {ω}_{SRK} is the acentric factor referenced in Eq . 1 above . & ( 5 )\end{matrix}$$

For storage tank loads where the equilibrium tank temperatures are less than the critical temperature and the loaded propellant bulk density is greater than the critical density, the compressed liquid pressure vs. equilibrium propellant temperature can be derived from Eqs. 3-5 to create Eq. 6, which is shown below:

$${P}_{liq , comp} ( T ) = {P}_{liq , sat} ( T ) + {0.3679 [ 1 - \frac{{ρ}_{liq , sat} ( T )}{{ρ}_{load}} ] [ \frac{{ρ}_{liq , sat} ( T )}{{ρ}_{load}} - {e}^{[ 1.0058 - \frac{T}{{T}_{crit}} ] B ( {ω}_{SRK} ) - 1} ]}^{- 1} A ( T ) {P}_{crit} . \qquad ( 6 )$$

In the supercritical and gas phase region, the Peng-Robinson Equation of State may be applied as follows:

$$\begin{matrix}P ( T ) = \frac{RT}{{ρ}_{load}^{- 1} - b} - \frac{a ( T )}{{ρ}_{load}^{- 2} + 2 b {ρ}_{load}^{- 1} - {b}^{2}} ; where & ( 7 ) \\ a ( T ) ≡ {\frac{0.42748 {R}^{2} {T}_{crit}^{2}}{{P}_{crit}} [ 1 + f ( {ω}_{SRK} ) [ 1 - \sqrt{T \text{/} {T}_{crit}} ] ]}^{2} , & ( 8 ) \\ f ( {ω}_{SRK} ) ≡ 0.37464 + 1.5423 {ω}_{SRK} - 0.26992 {ω}_{SRK}^{2} , and & ( 9 ) \\ b ≡ \frac{0.07780 {RT}_{crit}}{{P}_{crit}} . & ( 10 )\end{matrix}$$

Knowing the saturated liquid curve properties and the critical point of the monopropellant, the pressure-temperature curves of FIG. 10 consistently describe the state of many two-phase fluids with errors in fluid density and pressure typically much less than 10% and commonly less than about 1-2%.

Alternative methods for deriving the relationship between tank pressure, bulk fluid temperature, and bulk loaded density may include direct experimental measurements of fluids that have not been previously characterized. One method for producing similar families of curves as shown in FIG. 10 is to load a fluid to a bulk loaded density, heat and/or cool the tank, and measure the pressure response to changes in temperature.

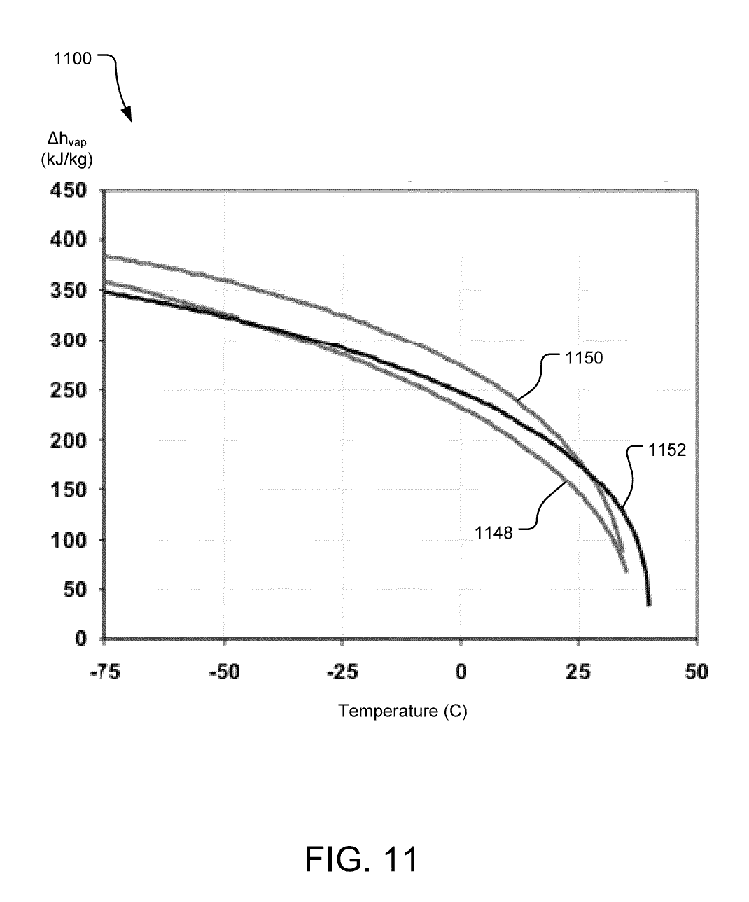

FIG. 11 illustrates a graph 1100 of enthalpy of nitrous oxide and two example monopropellants as a function of temperature. Curve 1148 illustrates the enthalpy of vaporization for nitrous oxide. Curve 1150 illustrates the enthalpy of vaporization for a first nitrous oxide fuel blend monopropellant. Curve 1152 illustrates the enthalpy of vaporization for a second nitrous oxide fuel blend monopropellant.

For non-equilibrium processes (e.g. warm or cool spots on a thermal phase separation storage tank), the monopropellant will tend to drive quickly to thermal equilibrium via evaporative cooling. For warm spots that the monopropellant is exposed to, the local vapor pressure will be higher than the rest of the vapor pressure within the storage tank, which causes boil-off to occur at the local warm spot. This boil-off will temporarily increase the pressure inside the storage tank until the high-pressure gases that are no longer in thermal equilibrium with the remainder of the storage tank force re-condensation to occur. Because of the lower vapor pressure of cooler regions in the storage tank, mass convection will occur driving monopropellant from the higher vapor pressure warm spots towards cooler spots in the storage tank where these gases can condense. The evaporative cooling at the warm spots will absorb heat, which cools the warm spot.

For temporary warm spots, the evaporative cooling quickly absorbs heat from the warm spots to bring them to thermal equilibrium. For warm spots sustained by external heat sources, the forced evaporative cooling will generate a sustained convection cell inside the storage tank that will rapidly transport heat from the warm spot to cooler regions in the tank to re-condense and release heat. This process provides an efficient mechanism for rapidly equilibrating momentary non-equilibrium temperature distributions within the storage tank. Eq. 11 estimates the local boil-off rate of the monopropellant at a warm spot in the storage tank, as follows:

$${\dot{m}}_{boil} = \frac{\dot{q}}{{h}_{vap}} ; where \\ \dot{m} is local boil \text{-} off rate , \\ \dot{q} is heat input , and \\ {h}_{vap} is enthalpy of vaporization of the monopropellant . \qquad ( 11 )$$

For constant non-equilibrium temperature differences in a thermal phase separation storage tank, due to the high vapor pressure of the liquid-phase monopropellant, the effective gravity induced on the liquid-phase portion of the example monopropellant can be quite strong even for small temperature gradients. The local acceleration felt on a fluid element by a temperature gradient across the fluid element can be described by Eq. 11, as follows:

$$accel = \frac{F}{m} = \frac{( p + Δ p ) A - pA}{ρ Ad Δ x} = \frac{1}{ρ} \frac{Δ p}{Δ x} \approx \frac{1}{ρ} ( \frac{d P}{d T} ) \frac{Δ T}{Δ x} ; where \\ ρ is monopropellant density , \\ d P \text{/} d T is the derivative of the monopropellant vapor pressure curve with respect to Temperature , \\ Δ T is a change in temperature a fluid element of the monopropellant , and \\ Δ x is a change in position of a fluid element of the monopropellant . \qquad ( 11 )$$

For saturated liquid fluid elements, the derivative of the monopropellant vapor pressure curve with respect to temperature can be derived from Eq. 1.

$$\begin{matrix}\frac{d {P}_{vap}}{d T} = [ \frac{d {P}_{r}^{( 0 )}}{d T} + {ω}_{SRK} \frac{d {P}_{r}^{( 1 )}}{d T} ] {P}_{vap} and \\ \frac{d {P}_{r}^{( 0 )}}{d T} ≡ \frac{1}{{T}_{c}} [ \frac{- 1.55664}{{T}_{r}} + 6.306619 {T}_{r}^{- 2} + 0.10511 {T}_{r}^{5} ] & ( 12 ) \\ \frac{d {P}_{r}^{( 1 )}}{d T} ≡ \frac{1}{{T}_{c}} [ \frac{1.265733}{{T}_{r}} + 3.085075 {T}_{r}^{- 2} + 0.514179 {T}_{r}^{5} ] . & ( 13 )\end{matrix}$$

For saturated gaseous-phase fluid elements, the derivative of the monopropellant pressure curve with respect to temperature can be derived from Eq. 7, as follows:

$$\frac{d P}{d T} = \frac{R}{{ρ}_{load}^{- 1} - b} + [ 1 + f ( {ω}_{SRK} ) [ 1 - \sqrt{T \text{/} {T}_{crit}} ] ] ( \frac{0.42748 {R}^{2} {T}_{crit}^{2} f ( {ω}_{SRK} )}{{P}_{crit} \sqrt{T {T}_{crit}} ( {ρ}_{load}^{- 2} + 2 b {ρ}_{load}^{- 1} - {b}^{2} )} ) \qquad ( 14 )$$

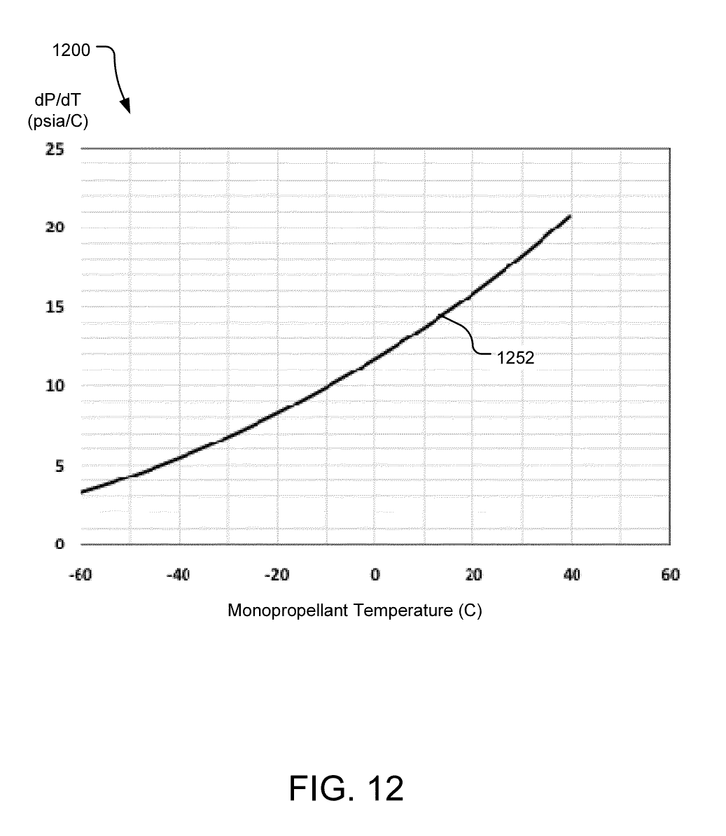

FIG. 12 illustrates a graph 1200 of a derivative of an example monopropellant vapor pressure curve as a function of temperature. Graph 1200 may be approximated by Eq. 14 above. For an example monopropellant with a fluid density of about 1.0 g/cc and a relatively low temperature gradient within a thermal phase separation storage tank of about 1.0° C./m, the effective gravity field on the liquid elements within the storage tank at a dP/dT of 10 psia/° C. (at about −10° C. as shown in FIG. 12) corresponds to about 7 g's of acceleration on the liquid fluid elements exposed to the thermal gradient. Conceptually, this is the acceleration of the storage tank that would need to occur along the temperature gradient to keep the liquid elements in contact with the warmer portions of the storage tank.

As a result, small induced temperature gradients along a storage tank wall can be used to readily control the location of liquid-phase monopropellant within the storage tank. The effective gravity vector of liquid elements of the monopropellant will align opposite the direction of the steady-state induced temperature gradient since the liquid elements preferentially react much more strongly to a gravity gradient than the gas elements for a given temperature gradient. The gas elements will tend to stratify near the hottest spots in the storage tank aligned with the temperature gradient.

If the monopropellant is in a two-phase regime, at the application of a heated warm spot, droplets in contact with the warmer wall will begin to evaporate and “jump” off the wall toward lower temperature regions of the storage tank. Transport of the liquid-phase monopropellant may occur by one or both direct mass convection of the liquid droplets as they are propelled towards cooler portions of the storage tank as well as more indirect evaporative/re-condensation transport that can occur under application of heat flux. Over time, under a weak or nonexistent external gravity field, only gaseous-phase monopropellant will be in contact with the heated wall, which insulates the heat source and allows the temperature gradient to be held with very low heat flux induced to the storage tank.

For propellant withdrawal from the storage tank under microgravity or zero gravity, if a small pressure drop is designed into the storage tank outlet during propellant flow, partial evaporative cooling through this throttled pressure drop will ensure that the storage tank outlet is the lowest temperature surface of the storage tank without requiring any additional heat source or sink on the storage tank to maintain the temperature gradient.

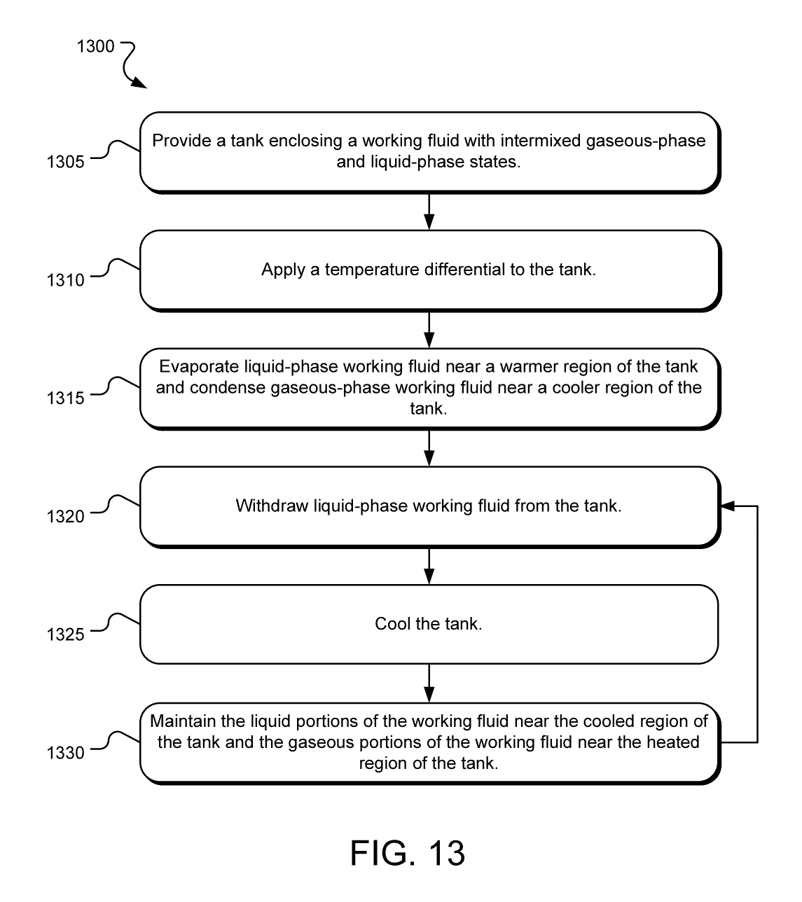

FIG. 13 illustrates example operations 1300 for thermally separating a liquid-phase working fluid from a gaseous-phase working fluid within a thermal phase separation storage tank. A providing operation 1305 provides a tank enclosing a working fluid with intermixed gaseous-phase and liquid-phase states. The phases are intermixed due to the lack of forces causing separation of the working fluid (e.g., little to no gravity or inertial forces).

An applying operation 1310 applies a temperature differential to the tank. In one implementation, the applying operation 1310 heats a first end of the tank in order to separate the phases of the working fluid stored within the tank. The heating may be accomplished by a dedicated heater or by placing the first end of the tank adjacent a higher temperature environment or heat-generating equipment. In another implementation, the applying operation 1310 cools a second end of the tank in order to separate the phases of the working fluid stored within the tank. The cooling operation may be accomplished by a dedicated heat-sink or by placing the second end of the tank adjacent an environment or equipment at a lower temperature. The applying operation 1310 may utilize one or both of heating and cooling to separate the phases of the working fluid stored within the tank.

An evaporation and condensation operation 1315 evaporates liquid-phase working fluid near a warmer region of the tank and condenses gaseous-phase working fluid near a cooler region of the tank. The cooler region of the tank is physically opposite the warmer region of the tank. The evaporation of the liquid working fluid near the warmer region of the tank is due to the locally higher temperature of the tank. The locally higher temperature evaporates the working fluid near the warmer region into an exclusively gaseous phase. Further, as working fluid near the warmer region of the tank is evaporated, gaseous-phase working fluid away from the warmer region of the tank condenses to maintain an overall quasi-equilibrium state within the tank. The net result is separation of the phases of the working fluid within the tank based on the temperature differential along the interior tank wall caused by the locally heated region (and/or a locally cooled region) of the tank.

A withdrawing operation 1320 withdraws liquid-phase working fluid from the tank at an outlet port. A cooling operation 1325 further cools the tank at the outlet port. In one implementation, the discharge of the working fluid via withdrawing operation 1320 discharges the working fluid into a lower pressure environment. The lower pressure environment may cause some or all of the discharged working fluid to vaporize, which absorbs thermal energy. The absorbed thermal energy near the outlet port of the tank cools the tank at the outlet port. In other implementation, cooling operation 1325 is not used.

A maintaining operation 1330 maintains the liquid-phase working fluid near the cooled region of the tank and the gaseous-phase working fluid near a heated region of the tank. In the absence of outside forces and heating loads, once the liquid-phase working fluid is separated from the gaseous-phase working fluid, the phases of the working fluid will remain separated. As a result, heating and/or cooling regions of the tank may be periodically implemented on demand or continuously implemented, as required. Further, operations 1320, 1325, 1330 may be iteratively repeated as working fluid is withdrawn from the tank for use, which cools the tank and maintains the phase separation within the tank. In one implementation, the heater is not used after the phases of working fluid within the tank are initially separated.

Further, a well-insulated tank may require less heating and/or cooling to maintain a temperature differential along the tank wall. In one implementation, 1 degree Celsius per meter distance along the wall from a heating or cooling source is sufficient to cause phase separation of the working fluid. The thermal phase separation discussed above is applicable to both high vapor pressure working fluid and low vapor pressure working fluids. However, lower vapor pressure working fluids typically take longer to equilibrate.

It should be understood that described operations may be performed in any order, unless explicitly claimed otherwise or a specific order is inherently necessitated by the claim language. The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
inducing phase-separation of a working fluid contained within a storage tank responsive to a temperature gradient applied across an interior surface of the storage tank.

2. The method of claim 1, wherein the phase-separation includes physical separation of gaseous-phase working fluid from liquid-phase working fluid.

3. The method of claim 1, wherein the inducing operation is performed in a microgravity environment.

4. The method of claim 1, wherein the temperature gradient is applied using a temperature variation source.

5. The method of claim 4, wherein the temperature variation source includes one or both of a heater and a heat sink.

6. The method of claim 1, wherein liquid-phase working fluid collects at a working fluid outlet of the storage tank.

7. The method of claim 1, wherein gaseous-phase working fluid collects at a working fluid outlet of the storage tank.

8. The method of claim 1, wherein the temperature gradient causes liquid-phase working fluid to collect at first region of the storage tank and gaseous-phase working fluid to collect at a second region of the storage tank opposite the first region of the storage tank.

9. The method of claim 1, wherein heated working fluid within the tank evaporates and cooled working fluid within the tank condenses.

10. The method of claim 1, wherein the working fluid is a monopropellant.

11. The method of claim 10, wherein the monopropellant is a nitrous oxide fuel blend.

12. A thermal phase-separation storage tank comprising:
a thermal variation source that applies a temperature gradient across an interior surface of the storage tank and induces phase-separation of a working fluid contained within the storage tank.

13. The thermal phase-separation storage tank of claim 12, wherein the phase-separation includes physical separation of gaseous-phase working fluid from liquid-phase working fluid.

14. The thermal phase-separation storage tank of claim 12, wherein the phase-separation occurs in a microgravity environment.

15. The thermal phase-separation storage tank of claim 12, wherein the temperature variation source includes one or both of a heater and a heat sink.

16. The thermal phase-separation storage tank of claim 12, wherein liquid-phase working fluid collects at a working fluid outlet of the storage tank.

17. The thermal phase-separation storage tank of claim 12, wherein gaseous-phase working fluid collects at a working fluid outlet of the storage tank.

18. The thermal phase-separation storage tank of claim 12, wherein the temperature gradient causes liquid-phase working fluid to collect at first region of the storage tank and gaseous-phase working fluid to collect at a second region of the storage tank opposite the first region of the storage tank.

19. The thermal phase-separation storage tank of claim 12, wherein heated working fluid within the tank evaporates and cooled working fluid within the tank condenses.

20. The thermal phase-separation storage tank of claim 12, wherein the working fluid is a monopropellant.

21. The thermal phase-separation storage tank of claim 12, wherein the monopropellant is a nitrous oxide fuel blend.

22. A system comprising:
a storage tank enclosing a working fluid existing in a liquid-phase and a gaseous-phase; and
a thermal variation source configured to apply a temperature gradient across an interior surface of the storage tank and induce phase-separation of the working fluid contained within the storage tank.
